(19) United States
(12) Patent Application Publication
(10) Pub. No.: US 2013/0218811 A1
(43) Pub. Date: Aug. 22, 2013

(54) METHOD OF PROVIDING HEATING TO A USER

(71) Applicant: Zenex Technologies Limited, (US)

(72) Inventor: Christopher C. Farrell, Haywards Heath (GB)

(73) Assignee: Zenex Technologies Limited, Exeter (GB)

(21) Appl. No.: 13/770,366

(22) Filed: Feb. 19, 2013

(30) Foreign Application Priority Data
Feb. 20, 2012 (GB) 1202829.6

(51) Int. Cl. G06Q 90/00

(52) U.S. Cl. CPC G06Q 90/00
USPC 705/500

(57) ABSTRACT

A method of providing heat to a user, comprising an energy retailer offering a supply energy over a contract period at a given amount of energy per use period.

### FIELD OF THE INVENTION

The present invention relates to a method of providing heating to one or more users.

### SUMMARY OF THE INVENTION

According to an aspect of the invention there is provided a method of providing heat to a user, comprising an energy retailer offering a supply energy over a contract period at a given amount of energy per use period.

The present invention may be worked in a geographical area, for example as defined by a grouping of several (possibly 10's or 100's) post codes, also known as zip codes.

Preferably at the approximate centre of this area is a retail store, “the central store”, where customers from many areas may visit but people local to the area visit more often.

The retailer may offer an energy product that focuses on reducing a customer's energy bills through energy efficiency improvements and which may include an appliance such as a heating and hot water boiler. The retailer and may add other products to this offering such as cavity wall or loft insulation.

Preferably the energy product that the retailer offers comprises a fixed price supply, over a contract period, of energy, the appliance and service for the appliance which is based on a calculated reduction in a user's bills taking into account the energy saving benefits, for example insulation and a new boiler, to be installed.

In the area of post codes or zip codes the homeowners may broadly be described as those who are in fuel poverty and those who are not in fuel poverty. Optionally the energy retailer may provide a day's energy tariff calculation where those home owners who were in fuel poverty would receive a predetermined rebate, for example supplied from those customers who were not in fuel poverty within the confines of the customers within that area serviced by the “central store” or by several of the retailer's stores. The rebate benefit may only be available to those people within the area around the central store and only supplied from the additional energy income of non fuel poverty homeowners who donated to the scheme. Such donations may be limited to those persons associated with the same “central store”.

This approach may foster good relations and community spirit within a local catchment area, helping to reduce fuel poverty and improve local community relations through reduction in instances of fuel poverty.

A retailer may also contribute to the rebate energy benefits by offering energy incentives from the consumer purchasing other items or services from the retailer.

An example is that customers may get a 5 pence per litre (or several cents per gallon) petrol token, but some of them , such as customer A does not have a car so this is no use to her, also the non fuel poverty family to which customer A belongs may not need the benefit of the 5 p fuel token and may gift this to the energy rebate scheme.

Thus the retailer by way of the “central store” is the link between all family types in a given area, the retailer operates the scheme and as a result of having many customers on energy contracts secures a beneficial purchase price for the energy, appliances and service delivery.

Preferably the energy contract may operate much like a mobile phone contract with additional energy consumption charged at variable rates subject to the terms of the contract. The price may increase with increased use above the fixed amount of the contract but also be linked to cold weather days assessed by the Government or a local agency as days of extreme weather hardship.

### DESCRIPTION OF THE INVENTION

A provider, which may be a retailer, may offer an energy product that allows residents of an area to take on the challenge of significantly reducing fuel poverty in an area Such an area may be defined by post code or zip code areas of , for example near a retail outlet.

Energy may be sold on a contract basis, in a manner similar to a mobile phone where one gets the phone along with the price of a user's minutes allocated on a monthly contract.

In an embodiment of the invention a user who enters into a contract with a supplier gets at least one of, and preferably both of, a boiler and a fuel, such as gas, equivalent to the ‘minutes’ of heat a user needs. The amount of gas provided may be defined by the user's existing consumption. This value may be modified by an amount based on a correction for the additional deemed efficiency of a new boiler provided as part of the contract and other energy efficiency improvements. As a result it pays a customer to improve the energy efficiency of their home, and get a new boiler and all servicing, relatively inexpensively. For example, at energy prices prevailing in the UK as of January 2012, a small domestic home system with new boiler fully serviced/ warranted and gas supply contract would be around £2 per day, fixed for ten years.

In an embodiment of the invention, there is a band of consumption for a given month, where a customer who stays within that band pays the same energy unit pricing. However homeowners who use more pay more, as opposed to the models used today where energy companies give customers a greater discount for using more, which does not promote energy efficiency.

Two types of systems are proposed, but these are example only and other thresholds of energy use, house size and component install may be offered:
1. Up to 3 bed homes and less than 20,000 kWhs existing gas consumption—based on a combination boiler system;
2. Above 3 bed and 20,000 kWhs, based on secondary heat recovery systems, such as that disclosed in WO2006/051266, optionally coupled to a combination boiler with a temporal hot water store and an optional plug in solar hot water top up.

So , in such an arrangement, a home dweller may obtain a new boiler, an energy supply contract and all servicing etc for a fixed price and less that they pay for your their gas today.

Thus, a user signing up to a supplier's offering may be provided with:
1) A new boiler on the wall,
2) 10 year service plan, including 5 year parts and labour warranty
3) a 10 year fixed energy contract based around a concept of a day's energy, averaged from previous bills reduced by the energy efficiency improvements that have been made.

The present invention presents a base line of fixed monthly costs and a flex value which is an upper energy consumption allowed at that agreed tariff, above the line, the customer pays a surcharge/penalty.

The method of the present invention can be linked to other business opportunities.

Thus, if the provider is a retailer, they may link to customer purchases of other products or offerings to this one. An example might be a ‘Heat and Eat’ or get ‘free energy days’ (or other amounts of gas) allocated to a user's contract when they or members of their family shop at given retailer or an affiliate.

Links to Home insurance deals, Car insurance deals, telephone contracts or Banking may also be made.

The method of the invention may also be extended to address charitable or social concerns. A provider may decide to benefit elderly local post code residents adjacent to their stores who do not have a car and hence do not use the petrol tokens or other tokens that the retailer may offer as part of another promotional service. Residents who live in the postcode catchment area might be entitled to a greater rebate on sales if the 5 p for petrol was scrapped for all shoppers and instead bulked up to offer ‘free energy days’ to local and in particular elderly residents and those households in fuel poverty.

Also, people signing up to the agreement could agree to pay a small premium support fee so that local elderly residents who are in fuel poverty may benefit from the generosity of local cash positive residents.

The UK, like many other countries, faces some difficult years ahead and businesses such as retail giants (but also traditional energy companies, such as British gas) can play a significant part in reducing the burden on society by helping consumers gain better value for money from their income and uncertain costs. This also applies to other countries.

A retailer, such as a regional or national supermarket, for example, could do much to improve local community cohesion through ‘heat and eat’ schemes that promote energy efficiency and quality food choices. Additionally it's possible to see how local families and elderly in fuel poverty could be helped by other local residents, within their store's postcode areas by offering discounted energy flex contracts to those households in difficulty, supported through other local better off families paying a small premium, used to support their other local residents.

1. A method of providing heat to a user, comprising an energy retailer offering a supply energy over a contract period at a given amount of energy per use period.

2. A method as claimed in claim 1, where the use period is weekly, monthly, quarterly, six-monthly or annually.

3. A method as claimed in claim 1, in which the cost of energy supply to a user increases if they use more than the given amount.

4. A method as claimed in claim 1, in which a boiler is provided as part of the contract.

5. A method as claimed in claim 4, in which fitting the boiler is provided as part of the contract.

6. A method as claimed in claim 1, in which servicing of a user's heating system is provided as part of the contract.

7. A method as claimed in claim 1, in which promotions offered by a retailer may be offset against fuel used.

8. A method as claimed in claim 1, in which a subsidy of cost is offered.

9. A method as claimed in claim 8, in which some users may offer to pay a premium so as to place money in a subsidy fund for the use of others.

10. A method as claimed in claim 9, in which the subsidy fund may receive money from and distribute subsidies to users in a geographical area defined by town, village or a plurality of zip codes.

11. A method as claimed in claim 1, in which the energy retailer is an intermediary (i.e. buy gas from others to resell).
